(19) United States
(12) Patent Application Publication
(10) Pub. No.: US 2025/0074509 A1
(43) Pub. Date: Mar. 6, 2025

(54) CONTROL OF ARTICULATED VEHICLE

(71) Applicant: Volvo Construction Equipment AB, Eskilstuna (SE)

(72) Inventors: Anders BOSTRÖM, TÄVELSÅS (SE); Gustav STRANDBERG, VÄXJÖ (SE)

(21) Appl. No.: 18/779,344

(22) Filed: Jul. 22, 2024

(30) Foreign Application Priority Data
Aug. 28, 2023 (EP) 23193771.5

(51) Int. Cl. B62D 12/00; B62D 6/00

(52) U.S. Cl. CPC B62D 12/00; B62D 6/002; B62D 6/008

(57) ABSTRACT

A computer system comprising processing circuitry. The processing circuitry is configured to obtain an articulation angle of an articulated vehicle and a velocity of the articulated vehicle. The articulation angle is controlled by a steering input unit, SIU, of a steering system of the articulated vehicle. The processing circuitry is further configured to, responsive to the articulation angle deviating from 0°, determine an angular speed for controlling the articulation angle towards 0° based on the articulation angle and a magnitude of the velocity such that a direction of the velocity is maintained. The processing circuitry is further configured to determine a steer-to-center torque for controlling the articulation angle towards 0° based on the angular speed, and provide the steer-to-center torque to the steering system for control of the articulation angle.

### PRIORITY APPLICATIONS

The present application claims priority to European Patent Application No. 23193771.5, filed on Aug. 28, 2023, and entitled “CONTROL OF ARTICULATED VEHICLE,” which is incorporated herein by reference in its entirety.

### TECHNICAL FIELD

The disclosure relates generally to steering control of vehicles. In particular aspects, the disclosure relates to control of an articulated vehicle. The disclosure can be applied to heavy-duty vehicles, such as trucks and construction equipment, among other vehicle types. Although the disclosure may be described with respect to a particular vehicle, the disclosure is not restricted to any particular vehicle.

### BACKGROUND

Articulated vehicles with permanent articulation are common in some heavy-duty applications such as off-road vehicles, e.g. articulated haulers, articulated dump trucks etc. Unlike traditional heavy-duty vehicles, such as tractors, rigid lorries or straight trucks, which have a rigid frame connecting the cab and the vehicle body, articulated vehicles feature a permanent pivot joint that allows the front and rear sections of the vehicle to articulate independently around the pivot joint. This unique construction gives them exceptional maneuverability and stability, making them well-suited for navigating rough and uneven surfaces while carrying heavy loads.

### SUMMARY

According to a first aspect of the disclosure, a computer system comprising processing circuitry is presented. The processing circuitry is configured to obtain an articulation angle of an articulated vehicle and a velocity of the articulated vehicle, wherein the articulation angle is controlled by a steering input unit, SIU, of a steering system of the articulated vehicle. The processing circuitry is further configured to, responsive to the articulation angle deviating from 0°, determine an angular speed for controlling the articulation angle towards 0° based on the articulation angle and a magnitude of the velocity such that a direction of the velocity is maintained and determine a steer-to-center torque for controlling the articulation angle towards 0° based on the angular speed. The processing circuitry is further configured to provide the steer-to-center torque to the steering system for control of the articulation angle. The first aspect of the disclosure may seek to improve difficulties in manually operating an articulated vehicle. A technical benefit may include improved stability as steer-to-center helps to improve the overall stability and control of the articulated vehicle. After completing a turn, the SIU naturally returns to the center position without altering a direction of the vehicle, which can reduce the chances of oversteering or understeering, thereby making the vehicle easier to handle. The operation of the articulated vehicle is simplified reducing training required by operators.

Optionally in some examples, including in at least one preferred example, the SIU is a SIU of the articulated vehicle. A technical benefit may include permitting local operators at the articulated vehicle to have the SIU automatically returned to the center, the driver experiences less effort and fatigue during long drives and repetitive maneuvers. Further to this, having the SIU being a SIU of the articulated vehicle allows for greater range of the articulated vehicle and decreases sensitivity to connectivity issues.

Optionally in some examples, including in at least one preferred example, the steering system is a steer-by-wire, SbW, steering system. A technical benefit may include simplifying the steering of the articulated vehicle.

Optionally in some examples, including in at least one preferred example, the computer system comprises the steering system. A technical benefit may include allowing for more freedom in methods of controlling the articulation angle.

Optionally in some examples, including in at least one preferred example, the processing circuitry is further configured to control a haptic feedback of the SIU based on the steer-to-center torque. A technical benefit may include improved stability as steer-to-center helps improve the overall stability and control of the articulated vehicle. After completing a turn, the SIU naturally returns to the center position without altering a direction of the vehicle, which can reduce the chances of oversteering or understeering, making the vehicle easier to handle. The operation of the articulated vehicle is simplified reducing training required by operators.

Optionally in some examples, including in at least one preferred example, the processing circuitry is further configured to control a hydraulic steering actuator of the steering system based on the steer-to-center torque. A technical benefit may include allowing the hydraulic steering actuator to return to center as hydraulic steering actuators have no inherent function of returning to zero.

Optionally in some examples, including in at least one preferred example, the processing circuitry is further configured to obtain a wanted articulation angle of the articulated vehicle, from the SIU, and determine a wanted articulation torque for controlling the articulation angle towards the wanted articulation angle. A technical benefit may include allowing control also of the articulated vehicle based on operator input.

Optionally in some examples, including in at least one preferred example, the processing circuitry is further configured to control the articulation angle by applying the wanted articulation torque and the steer-to-center torque to a steering actuator of the steering system. A technical benefit may include permitting direct control of the articulation angle allowing smooth and controlled steer-to-center functionality.

Optionally in some examples, including in at least one preferred example, the computer system further comprises the steering system, wherein the SIU is a SIU of the articulated vehicle, the steering system is a steer-by-wire, SbW, steering system, wherein the processing circuitry is further configured to: control a haptic feedback of the SIU based on the steer-to-center torque; control a hydraulic steering actuator of the steering system based on the steer-to-center torque; obtain a wanted articulation angle of the articulated vehicle, from the steering input unit, SIU, and determine a wanted articulation torque for controlling the articulation angle towards the wanted articulation angle; and control the articulation angle by applying the wanted articulation torque and the steer-to-center torque to a steering actuator of the steering system. A technical benefit may include all the benefits of the previous examples.

According to a second aspect of the disclosure, an articulated vehicle is presented. The articulated vehicle comprises a steering system and the computer system according to the first aspect. The second aspect of the disclosure may seek to provide a vehicle that reduces some if the difficulties in operating an articulated vehicle. A technical benefit may include improved stability as steer-to-center helps improve the overall stability and control of the articulated vehicle. After completing a turn, the SIU naturally returns to the center position without altering a direction of the vehicle, which can reduce the chances of oversteering or understeering, making the vehicle easier to handle. The operation of the articulated vehicle is simplified reducing training required by operators.

Optionally in some examples, including in at least one preferred example, the articulated vehicle is a heavy-duty vehicle.

Optionally in some examples, including in at least one preferred example, the steering system is a hydraulic steering system.

Optionally in some examples, including in at least one preferred example, the articulated vehicle is a SbW vehicle.

According to a third aspect of the disclosure, a computer implemented method is presented. The method comprises obtaining, by processing circuitry of a computer system, an articulation angle of an articulated vehicle and a velocity of the articulated vehicle, wherein the articulation angle is controlled by a SIU, of a steering system of the articulated vehicle. The method further comprises, responsive to the articulation angle deviating from 0°, determining, by processing circuitry of the computer system, an angular speed for controlling the articulation angle towards 0° based on the articulation angle and a magnitude of the velocity such that a direction of the velocity is maintained, and determining, by processing circuitry of the computer system, a steer-to-center torque for controlling the articulation angle towards 0° based on the angular speed. The method further comprises providing, by processing circuitry of the computer system, the steer-to-center torque to the steering system for control of the articulation angle. The third aspect of the disclosure may seek to improve difficulties in operating an articulated vehicle. A technical benefit may include improved stability as steer-to-center helps improve the overall stability and control of the articulated vehicle. After completing a turn, the SIU naturally returns to the center position without altering a direction of the vehicle, which can reduce the chances of oversteering or understeering, thereby making the vehicle easier to handle. The operation of the articulated vehicle is simplified reducing training required by operators.

According to a fourth aspect of the disclosure, a computer program product comprising program code for performing, when executed by a processing circuitry, the method of the third aspect.

According to a fifth aspect of the disclosure, a non-transitory computer-readable storage medium comprising instructions, which when executed by a processing circuitry, cause the processing circuitry to perform the method of the third aspect.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary schematic side view of an articulated vehicle according to an example.

FIG. 2A is an exemplary block diagram of an articulated vehicle according to an example.

FIG. 2B is an exemplary block diagram of an articulated vehicle according to an example.

FIG. 3A is an exemplary schematic top view of an articulated vehicle according to an example.

FIG. 3B is an exemplary schematic top view of an articulated vehicle according to an example.

FIG. 4 is an exemplary system architecture of a steering centerer according to an example.

FIGS. 5A-5C are exemplary schematic top views illustrating maneuvering of an articulated vehicle according to an example.

FIGS. 6A-6C are exemplary schematic top views illustrating maneuvering of an articulated vehicle according to an example.

FIG. 7 are exemplary time series plots of data relating to control of an articulated vehicle according to an example.

FIG. 8 are exemplary time series plots of data relating to control of an articulated vehicle according to an example.

FIG. 9 is an exemplary block diagram of a computer system according to an example.

FIG. 10 is an exemplary flow chary of a method according to an example.

FIG. 11 is an exemplary schematic view of a processing circuitry according to an example.

FIG. 12 is a schematic view of a computer program product according to an example.

FIG. 13 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

Operating articulated vehicles, whether heavy-duty articulated trucks or heavy-duty articulated vehicles with permanent articulation, comes with its set of challenges. These challenges can vary depending on the type of vehicle, the environment, and the specific tasks involved. While articulated vehicles are designed to have improved maneuverability, articulated vehicles may still be challenging to handle, especially in tight spaces or congested urban areas. An operator of an articulated vehicle must be adept at managing the articulation joint. This requires precise control to ensure smooth movements and prevent any sudden shifts that could lead to instability or accidents. The operator must be skilled in navigating through narrow roads, making turns, and avoiding obstacles without causing damage to the vehicle or surroundings. Many articulated vehicles are designed for off-road use, where the terrain may be uneven, slippery, or unpredictable. Operators must be familiar with off-road driving techniques and have a good understanding of the vehicle's capabilities in such environments. Operating articulated vehicles with permanent articulation requires specialized training. The unique steering and maneuvering characteristics of these vehicles demand skilled and experienced operators. Inadequate training may lead to accidents, reduced efficiency, and increased wear and tear.

The present disclosure will provide functions, features and examples that may simplifies operation of an articulated vehicle. Specifically, steer-to-center (StC) functionality of articulated vehicles may be provided in a way that offers operation of an articulated vehicle that is similar to that of a conventional (rigid) vehicle, i.e. a vehicle with Ackermann steering. One effect may be a reduced need of operator training, decreased risk of accidents and improved precision in steering of the articulated vehicle.

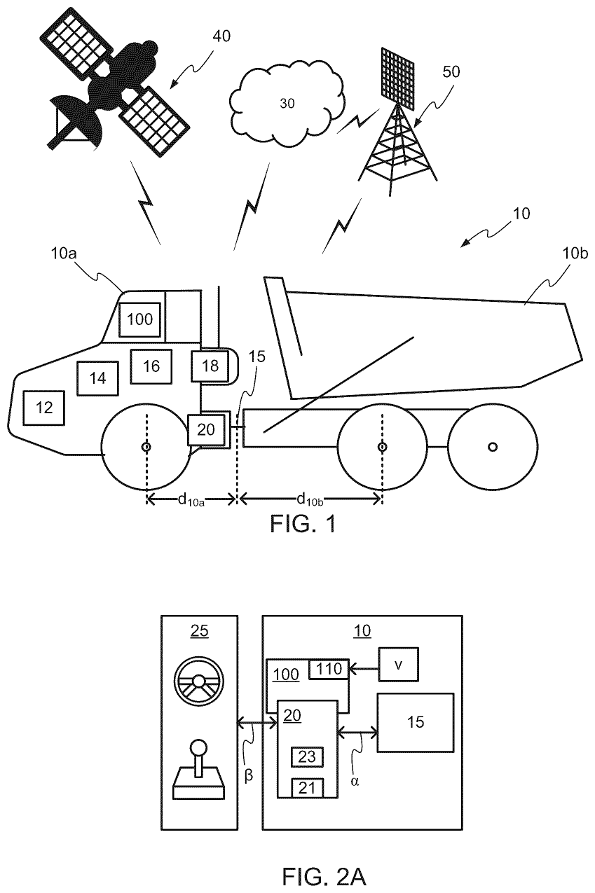

In FIG. 1, a planar side view of an exemplary articulated vehicle 10 according to the present disclosure is shown. The vehicle 10 in FIG. 1 is a heavy-duty vehicle in the form of an articulated hauler, sometimes referred to as an articulated dump truck (ADT). This is one example chosen to illustrate an articulated vehicle 10 according to the disclosure and other types of articulated vehicles are equally compatible with the teachings of the present disclosure. Other articulated vehicles may be exemplified by, but not limited to, articulated trucks, articulated loaders, articulated buses, articulated trams, articulated cranes, articulated mobile elevated work platforms (MEWP) etc. The articulated vehicle 10 comprises a tractor unit (pull unit i.e. the front cab/section of the articulated hauler) 10a and a trailing unit 10b (i.e. the dump body of the articulated hauler). The pull unit 10a and the trailing unit 10b are pivotably connected at an articulation joint 15. The articulation joint 15 allows pull unit 10a and the trailing unit 10b of the vehicle 10 to pivot relative to each other about a vertical axis when the ground surface is perfectly flat/horizontal.

The articulated vehicle 10 further comprises all vehicle units and associated functionality to operate as expected, such as a powertrain, chassis, and various control systems. The vehicle 10 comprises one or more propulsion sources 12. The propulsion source 12 may be any suitable propulsion source 12 exemplified by, but not limited to, one or more or a combination of an electrical motor, an internal combustion engine such as a diesel, gas or gasoline powered engine. The articulated vehicle 10 further comprises an energy source 14 suitable for providing energy for the propulsion source 12. That is to say, if the propulsion source 12 is an electrical motor, a suitable energy source 14 would be a battery or a fuel cell. The articulated vehicle 10 further comprises sensor circuitry 16 arranged to detect, measure, sense or otherwise obtain data relevant for operation of the articulated vehicle 10. The sensor circuitry 16 may comprise one or more of an accelerometer, a gyroscope, a wheel Speed Sensor, an ABS sensor, a throttle position sensor, a fuel level sensor, a temperature Sensor, a pressure sensor, a rain sensor, a light sensor, proximity sensor, a lane departure warning sensor, a blind spot detection sensor, a TPMS sensor etc. The data relevant for operation of the articulated vehicle 10 may include, but is not limited to, one or more of a speed of the articulated vehicle 10, a weight of the articulated vehicle 10, an inclination of the articulated vehicle 10, a status of the energy source 14 of the articulated vehicle 10 (state of charge, fuel level etc.), a presence of road users in a vicinity of the articulated vehicle 10, a current speed limit of a current road travelled by the articulated vehicle 10, an articulation angle of the articulated vehicle 10 etc.

The articulated vehicle 10 may in some examples comprise communications circuitry 18 configured to receive and/or send data. The articulated vehicle 10 may be in operative communication with external devices, such as external computer systems 30, exemplified by a cloud server in FIG. 1. The connection to the external devices may be provided by e.g. the communications circuitry 18. The articulated vehicle 10 may communicate with the cloud server 30 directly or via a communications interface such as a cellular communications interface 50, such as a radio base station. The cloud server 30 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The articulated vehicle 10 may further be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 40 to determine a geographical location of the vehicle 10.

The articulated vehicle 10 further comprises a steering system 20 and a computer system 100.

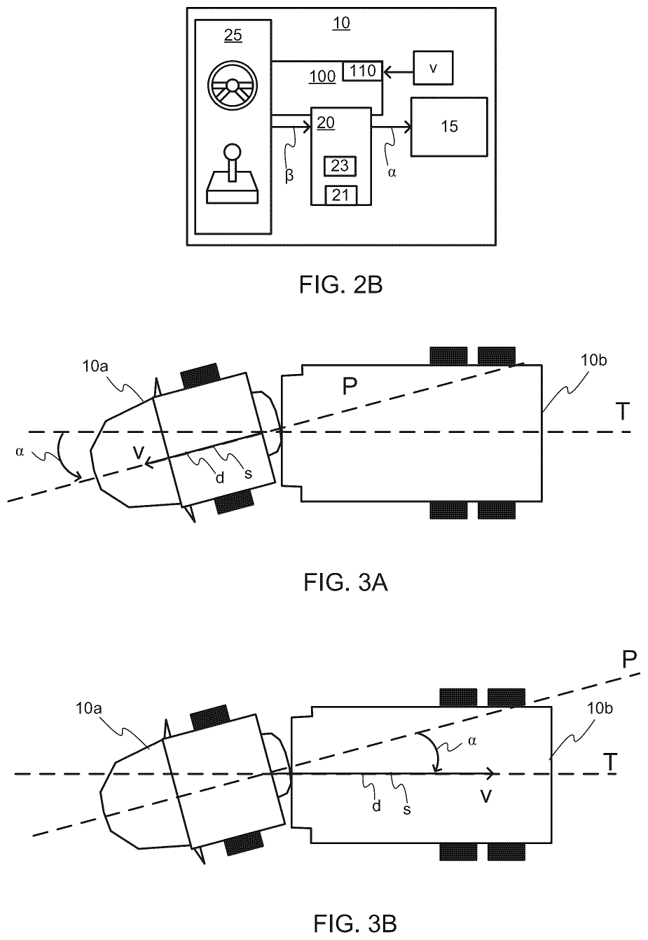

As seen on the exemplary block diagram of an articulated vehicle 10 in FIG. 2A, and FIG. 2b, the computer system 100 comprises processing circuitry 110. Further, the steering system 21 comprises processing circuitry 21. The processing circuitry 21 of the steering system 20 may be part of the processing circuitry 110 of the computer system 100. The computer system 100 may comprise the steering system 20. The steering system 20 is configured to control steering of the articulated vehicle 10, i.e. to control an articulation angle α of the articulation joint 15 based on a wanted (i.e. desired) articulation angle β. The wanted articulation angle β is provided by a steering input unit (SIU) 25 operatively connected to the steering system 20. In detail, the wanted/desired articulation angle β evolves proportionally with a position of the SIU 25, and more precisely to the deviation of the position of the SIU 25 relative to a neutral/straight position of the SIU 25. As a result, if the SIU 25 has been operated to its maximum limit relative to the neutral/center position, then the wanted/desired articulation angle β corresponds to a maximum allowable articulation angle. Similarly, if the SIU 25 has been moved halfway, e.g. at mid-course, then the wanted articulation angle β is equal to half of the maximum allowable articulation angle (according to proportionality law). The SIU 25 may be a remotely located SIU 25 for remote control of the articulated vehicle 10. However, as seen in FIG. 2B, the SIU 25 may also be part of the articulated vehicle 10. The SIU 25 may any suitable device such as a steering wheel, a joystick, keyboard etc. In some examples, no mechanical connection is provided between the SIU 25 and the articulation joint 15, this is generally known as a steer by wire (SbW) system. Due to the complexity of steering systems for articulated vehicles 10, the steering is generally provided by a SbW system.

The steering system 20 may control the articulation angle α in one or more different ways. The articulation angle α may be controlled by a steering actuator 23 of the steering system 20. The steering actuator 23 may be a hydraulic steering actuator comprising a hydraulic system arranged to control movement of the articulation angle α. In a hydraulic steering actuator, hydraulic cylinders are connected to the articulation joint 15 and provide required force to articulate the articulated vehicle 10. By controlling the flow of hydraulic fluid to the cylinders, the operator may adjust the articulation angle α. The steering actuator 23 may be a differential steering actuator configured to adjust a relative speed of wheels on a left and right sides of the articulation joint 15. The steering actuator 23 may be an electrical steering actuator comprising electric motors arranged to control movement of the articulation angle α. The examples of steering actuators 23 are given as way of example and should not be considered exhaustive.

With reference to FIG. 3A and FIG. 3B, some definitions relevant for the present disclosure will be provided. FIG. 3A is a top view of an articulated vehicle 10 moving in a (forward) direction d with a speed s. The speed s and the direction d are indicated by a velocity v. Generally, the velocity v is a vector having the direction d and having a magnitude describing the speed s. However, for examples of the present disclosure, the velocity v need only contain a speed s (a magnitude of the velocity v) and a direction indicator indicating a forward or a backwards direction of the articulated vehicle 10. That is to say, the direction d does not have to be a direction in a plane. In FIG. 3A, the tractor unit 10a of the articulated vehicle 10 is the forward one (leading unit) of the tractor unit 10a and the trailing unit 10b. As the vehicle is an articulated vehicle 10, the forward one of the tractor unit 10a and the trailing unit 10b is oriented in the direction d of the velocity v. This is indicated in FIG. 3A by a tractor unit axis P coinciding with the direction d of the velocity v. However, the articulated vehicle 10 in FIG. 3A is turning to the left which is visualized by a trailing unit axis T being different from the tractor unit axis P. The articulation angle α is formed between the trailing unit axis T and the tractor unit axis P. To clarify, in FIG. 3B, the same articulated vehicle 10 as in FIG. 3A is shown, but FIG. 3B, the articulated vehicle is reversing. This means that, in FIG. 3B, the trailing unit 10b is the forward one (leading unit) of the tractor unit 10a and the trailing unit 10b. This is indicated in FIG. 3B by the trailing unit axis T coinciding with the direction d of the velocity v. The articulation angle α is formed between the tractor unit axis P and the trailing unit axis T.

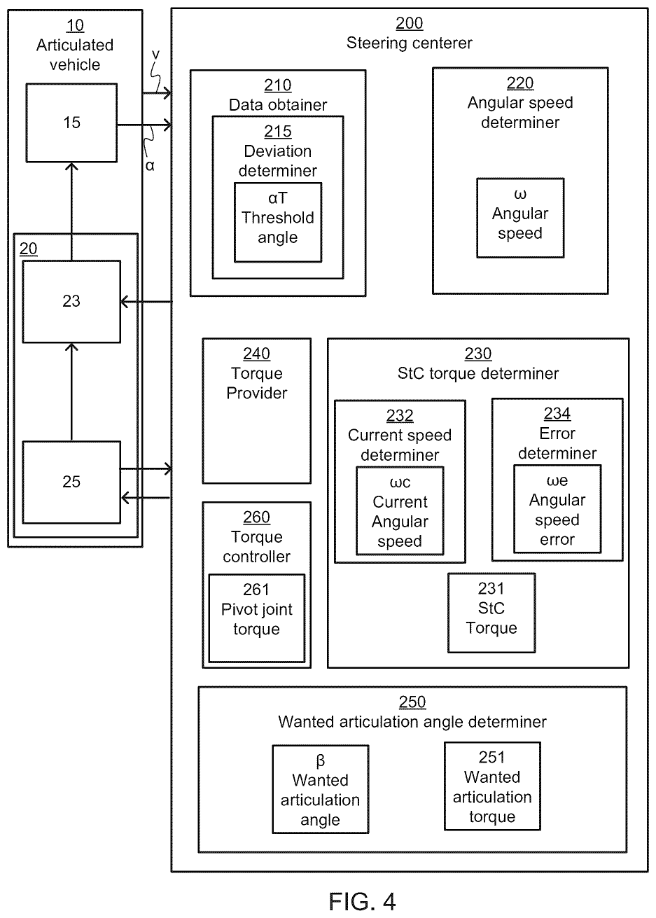

In FIG. 4, a system diagram of a steering centerer 200 for an articulated vehicle 10 is shown. The steering centerer 200 is advantageously implemented in software and the different functions and features described may be performed by the processing circuitry 110 of the computer system 100, and/or the processing circuitry 21 of the steering system 20. The steering centerer 200 may, in some examples, be configured to operate between the steering system 20 and the steering actuator 23 operating on data to/from the steering actuator 23. In some examples, the steering centerer 200 is configured to operate between the steering system 20 and the SIU 25 operating on data to/from the SIU 25. In some examples, the steering centerer 200 is configured to operate in parallel with, or as part of, the steering system 20 such that it may operate both on data to/from the SIU 25 and on data to/from the steering actuator 23.

The steering centerer 200 comprises a data obtainer/collector 210 configured to obtain/collect the articulation angle α of the articulated vehicle 10 and the velocity v of the articulated vehicle 10. The articulation angle α may be provided by sensor circuitry 16 configured to measure, detect or otherwise obtain data relating to the articulation joint 15. In some examples, wherein an input angle indicated by SIU 25 correlates (is proportional) to the articulation angle α, i.e. each angle of the SIU 25 is equal to an articulation angle α multiplied by some steering wheel ratio. In such examples, the articulation angle α may be provided by sensor circuitry 16 which is configured to measure, detect or otherwise obtain data relating to the wanted articulation angle β. The velocity v may be provided by sensor circuitry 16 which is configured to measure, detect or otherwise obtain data relating to the propulsion of the vehicle 10. It should be mentioned that the data obtainer 210 may be configured to obtain the velocity v by obtaining a speed s of the vehicle, the articulation angle α and data (from e.g. a gearbox of the vehicle 10) indicating if the vehicle 10 is moving forward or reversing. Data indicating if the vehicle 10 is moving forward or reversing may be provided by indicating a gear of the vehicle 10, which one is a forward one of the tractor unit 10a or the trailing unit 10b or by a simple indicator.

The data obtainer 210 comprises a deviation determiner 215. The deviation determiner 215 is configured to determine if the articulation angle α deviates from 0°. Generally, if the articulation angle α is substantially 0°, there is no need to perform further functionality of the steering centerer 200 and in some examples, the data obtainer 210 obtains the articulation angle α and only if the deviation determiner 215 determines that the articulation angle α deviates from 0° is the velocity v obtained. In some examples the deviation determiner 215 determines that the articulation angle α deviates from 0° if the articulation angle α deviates from 0° by more than a predetermined threshold angle αT. The threshold angle αT may depend on a speed s of the articulated vehicle 10 or be a constant threshold angle αT. In some examples the threshold angle αT is below 5°, in some examples the threshold angle αT is below 3° and in some examples the threshold angle αT is below 1.5°.

The steering centerer 200 further comprises an angular speed determiner 220. The angular speed determiner/calculator 220 is configured to determine/calculate a wanted/desired angular speed ω for controlling the articulation angle α of the articulated vehicle 10 towards 0°. The wanted/desired angular speed ω is determined based on the articulation angle α and the speed s, i.e. a magnitude of the velocity v such that a direction d of the velocity v is maintained. The angular speed ω may be determined as [ω=f(α,s,d)], subject to d=constant.

As the direction d is to be maintained, this means (this will be explained in further detail in later sections) that the rear one of the tractor unit 10a and the trailing unit 10b should follow, substantially, track in track with the forward one of the tractor unit 10a and the trailing unit 10b. The angular speed determiner 220 may be configured to determine the angular speed ω only if the deviation determiner 215 determines that the articulation angle α deviates from 0°.

The steering centerer 200 further comprises a StC torque determiner 230. The StC torque determiner 230 is configured to determine a StC torque 231 for controlling the articulation angle α towards 0° based on the angular speed ω determined by the angular speed determiner 220. In other words, the StC torque 231 is determined so as to decrease the articulation angle towards 0° at a specific angular speed corresponding to the angular speed ω. The StC torque determiner 230 may be implemented as a control loop (closed loop control). To this end, the StC torque determiner 230 may comprise a current/actual angular speed determiner 232, or current speed determiner 232 for short. The current angular speed determiner 232 may be configured to determine a current/real/actual angular speed ωc by dividing a difference between two articulation angles α with a difference in time between the two articulation angles α. The StC torque determiner 230 may further comprise an angular speed error determiner 234, or error determiner 234 of short. The angular speed error determiner 234 may be configured to determine an angular speed error we by comparing the current angular speed ωc to the wanted/target angular speed ω determined by the angular speed determiner 220. If the current angular speed ωc is equal to the angular speed ω determined by the angular speed determiner 220, i.e. the angular speed error we is substantially zero, the StC torque 231 is not changed. If the current angular speed ωc is greater than the angular speed ω determined by the angular speed determiner 220, i.e. the angular speed error we is positive, the StC torque 231 is decreased. If the current angular speed ωc is lower than the angular speed ω determined by the angular speed determiner 220, i.e. the angular speed error we is negative, the StC torque 231 is increased. The StC torque 231 may be limited to a maximum StC torque to ensure that it does not reach too high values.

The steering centerer 200 further comprises a torque provider 240 configured to provide the StC torque 231 for control of the articulation angle α. Control of the articulation angle α may be performed in different ways and will be further explained in later sections. The torque provider 240 may provide the StC torque 231 to the steering system 20 of the articulated vehicle 10. The torque provider 240 may provide the StC torque 231 for further processing by e.g. the computer system 100 or other functions or features of the steering centerer 200.

Optionally, the steering centerer 200 may be configured to also consider the wanted articulation angle β. To this end, the data obtainer 210 may be configured to further obtain the wanted articulation angle β from the SIU 25. The steering centerer 200 may further comprise a wanted articulation angle determiner 250. In some examples, the data obtainer 210 may be configured to further obtain a SIU angle or deviation from the SIU 25 and the wanted articulation angle determiner 250 may be configured to determine the wanted articulation angle β based on the SIU angle and a steering ratio associated with the SIU 25. The wanted articulation angle determiner 250 is configured to determine a wanted articulation torque 251 based on the wanted articulation angle β. The torque provider 240 may further be configured to provide the wanted articulation torque 251 to the steering system 20 of the articulated vehicle 10. The torque provider 240 may provide the wanted articulation torque 251 for further processing by e.g. the computer system 100 or other functions or features of the steering centerer 200.

In some optional examples, the steering centerer 200 further comprises a torque controller 260. The torque controller 260 is configured to control (or cause control of) a pivot joint torque 261 to control the articulation angle α of the articulated vehicle 10. The torque controller 260 is configured to control the pivot joint torque 261 based on the StC torque 231. In some examples, the Pivot joint torque 261 is controlled based on the wanted articulation angle β, which may be provided by the SIU 25, and the StC torque 231 may be applied to the SIU 25. In examples wherein the wanted articulation torque 251 is determined by the wanted articulation angle determiner 250, the torque controller 260 may be configured to control the pivot joint torque 261 also based on the wanted articulation torque 251. It may very well be that the wanted articulation torque 251 is a torque with an opposite direction than the StC torque 231. Depending on the magnitudes of the wanted articulation torque 251 and the StC torque 231 and how the torque controller 260 is configured to control the articulation angle α, pivot joint torque 261 may be the wanted articulation torque 251, the StC torque 231 or a combination (e.g. sum or difference) of the wanted articulation torque 251 and the StC torque 231.

Depending on how the steering centerer 200 is configured, i.e. which features of the steering system 20 or the SIU 25 the steering centerer 200 is configured to control, the torque controller 260 may control the pivot joint torque 261 differently.

The torque controller 260 may control the pivot joint torque 261 by controlling the steering actuator 23 to exert the pivot joint torque 261. Assuming that the SIU 25 is a keyboard no SIU angle is indicated by a position of the SIU 25 and no feedback from the steering system 20 to the SIU 25 is required. However, if the SIU 25 is a steering wheel, a joystick or any other device configurable to indicate a steering angle, the steering angle of the SIU 25 may be updated to reflect the change in articulation angle α. To this end, the steering system 20 may detect a change in articulation angle α and control the SIU 25 to reflect this change, assuming that the SIU 25 is configurable to provide haptic feedback to the operator/driver.

The torque controller 260 may control the pivot joint torque 261 by controlling a haptic feedback exerted by the SIU 25. The exerted haptic feedback causes the steering angle indicated by the SIU 25 to change. The steering system 20 may detect the change in steering angle indicated by the SIU 25 and control the steering actuator 23 to exert a torque corresponding to the torque indicated by the SIU 25.

The torque controller 260 may control the pivot joint torque 261 by controlling a haptic feedback exerted by the SIU 25 to correspond to the pivot joint torque 261 and control the steering actuator 23 to exert the pivot joint torque 261.

In the examples of the torque controller 260 presented above, control of the pivot joint torque 261 based on the wanted articulation torque 251 may be provided either by the steering system 20 or the steering centerer 200. The skilled person appreciates that flexibility of implementing the steering centerer 200 and understands, after reading the present disclosure, how to control of the pivot joint torque 261 also based on the wanted articulation torque 251.

The StC torque 231 determined as taught herein, i.e. based on the angular speed ω, allows the articulated vehicle 10 to keep moving along the same axis P, T responsive to an operator not applying any torque, or otherwise providing input to, the SIU 25. This means that, at any given point in time, rear one of the tractor unit 10a and the trailing unit 10b should be steered such that, when the wheels of the rear one of the tractor unit 10a and the trailing unit 10b reach the position at which the pivot joint 15 was at the given point in time, the articulation angle α should be zero. This will be further exemplified in the following.

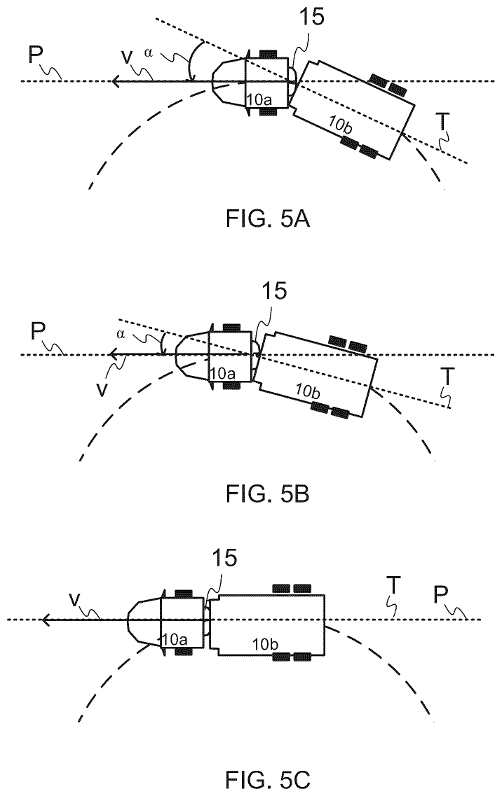

With reference to FIG. 5A, FIG. 5B and FIG. 5C, one effect of the present disclosure will be explained. FIG. 5A, FIG. 5B and FIG. 5C show a top view of the same articulated vehicle 10 at three different points in time. At a first point in time, FIG. 5A, an operator of the articulated vehicle 10 releases a grip of a SIU 25 controlling the steering system 20 of the articulated vehicle 10. This means that the articulated vehicle 10 according to the disclosure will straighten up and follow the tractor unit axis P. The speed s and the articulation angle α of the articulated vehicle 10 are obtained as mentioned in reference to FIG. 4. The angular speed w is determined such that the direction d of the tractor unit 10a is maintained. This means that the articulation angle α should be zero when the articulated vehicle 10 has moved sufficiently forward such that the wheels of the trailer unit 10b are at a position where the pivot joint 15 is located in FIG. 5A. Assuming that a distance d_{10b} (see FIG. 1) from a forward one of wheel axis of the trailing unit 10b to the pivot joint 15 is known, a time t it takes for the forward one of wheel axis of the trailing unit 10b to reach the pivot joint 15 location in FIG. 5A may be estimated as

$$t = \frac{{d}_{10 b}}{s} .$$

From this, the angular speed ω may be determined as

$$ω = \frac{a}{t} .$$

Such an approximation of the angular speed ω is sufficiently accurate assuming that new calculations of the angular speed w are made sufficiently often. If fewer calculations are made, the distance travelled by the trailing unit 10b between calculations may be considered an arc-shaped path of the trailing unit 10b, to increase accuracy. In such situations, the time t it takes for the forward one of wheel axis of the trailing unit 10b to reach the pivot joint 15 location in FIG. 5A may be estimated as

$$t = \frac{2 π}{α} \cdot \frac{2 \cdot π \cdot {d}_{10 b}}{s} .$$

The angular speed ω may be determined as indicated above. The StC torque 231 may be determined as explained in reference to FIG. 4 and the pivot joint torque 261 may be controlled as explained in reference to FIG. 4. As a result, at a second point in time, FIG. 5B, the articulated vehicle 10 has moved a distance forward and the articulation angle α is reduced compared to the articulation angle α of FIG. 5B. However, the direction d is unchanged and the articulated vehicle 10 is moving along the same tractor unit axis Pas in FIG. 5A. Assuming that the speed s is unchanged, the angular speed ω will decrease as the articulation angle α approaches zero and, when the articulation angle α is zero, see FIG. 5C, the angular speed ω will be zero. In FIG. 5C, the tractor unit axis P and the trailing unit axis T coincide.

In some examples, specifically advantageous for computer implemented examples, the direction d may be maintained, i.e. kept constant, between consecutive discrete time points (samples) such that d (n)=d (n+1) where n is a discrete time point with sample time Tₛ. From this, a time update of the direction may be expressed as d(n+1)=d(n)+Tₛ·f(v,α,ω). As the direction d is kept constant and the sample time Tₛ≠0, f(v,α,ω)=0 must be satisfied. From this, the wanted angular speed ω may be expressed as a function of the velocity v and the articulation angle α, ω=g(v,α).

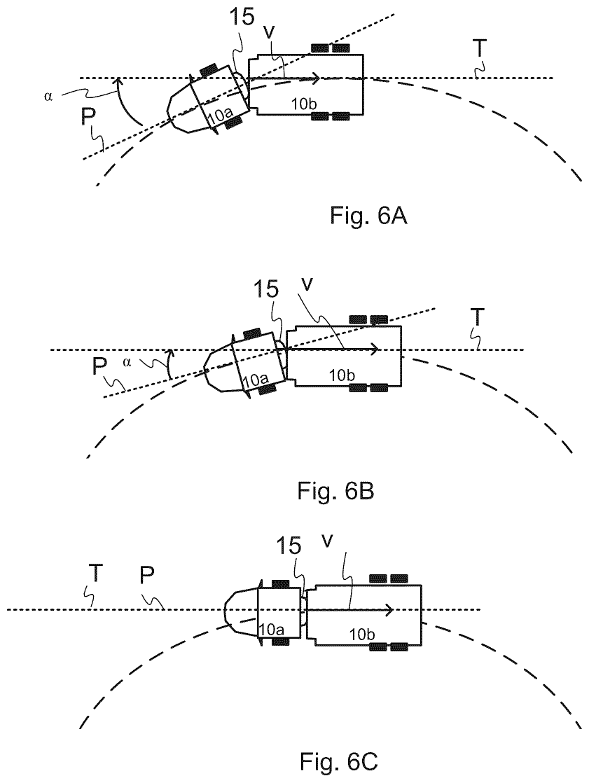

A corresponding example as the one presented with reference to FIG. 5A, FIG. 5B and FIG. 5C is shown in FIG. 6A, FIG. 6B and FIG. 6C, for a reversing articulated vehicle. At a first point in time, FIG. 6A, an operator of the articulated vehicle 10 lets go of (releases) a SIU 25 controlling the steering system 20 of the articulated vehicle 10. This means that the articulated vehicle 10 according to the disclosure will straighten up and follow the trailing unit axis T. The angular speed ω is determined such that the direction d of the trailing unit 10b is maintained. This means that the articulation angle α should be zero when the articulated vehicle 10 has moved sufficiently backwards such that the wheels of the tractor unit 10a are at a position where the pivot joint 15 is located in FIG. 6A. Assuming that a distance d₁₀ₐ (see FIG. 1) from a wheel axis of the tractor unit 10a to the pivot joint 15 is known, a time t it takes for the wheel axis of the tractor unit 10a to reach the pivot joint 15 location in FIG. 6A may be estimated as

$$t = \frac{{d}_{10 a}}{s} .$$

The angular speed ω may be determined as presented in reference to FIG. 5A, FIG. 5B and FIG. 5C. As above, the accuracy of the approximation may be increased by considering the arc-shaped path of the tractor unit 10a. That is to say, the time t it takes for the wheel axis of the tractor unit 10a to reach the pivot joint 15 location in FIG. 6A may be estimated as

$$t = \frac{2 π}{α} \cdot \frac{2 \cdot π \cdot {d}_{10 a}}{s} .$$

The angular speed ω may be determined as presented above in the forward moving examples, e.g. in reference to FIG. 5A, FIG. 5B and FIG. 5C. The StC torque 231 may be determined as explained in reference to FIG. 4 and the pivot joint torque 261 may be controlled as explained in reference to FIG. 4. As a result, at a second point in time, FIG. 6B, the articulated vehicle 10 has moved a distance backwards and the articulation angle α is reduced compared to the articulation angle α of FIG. 6B. However, the direction d is unchanged and the articulated vehicle 10 is moving along the same trailing unit axis T as in FIG. 6A. Assuming that the speed s is unchanged, the angular speed ω will decrease as the articulation angle α approaches zero and, when the articulation angle α is zero, see FIG. 6C, the angular speed w will be zero. In FIG. 6C, the tractor unit axis P and the trailing unit axis T coincide.

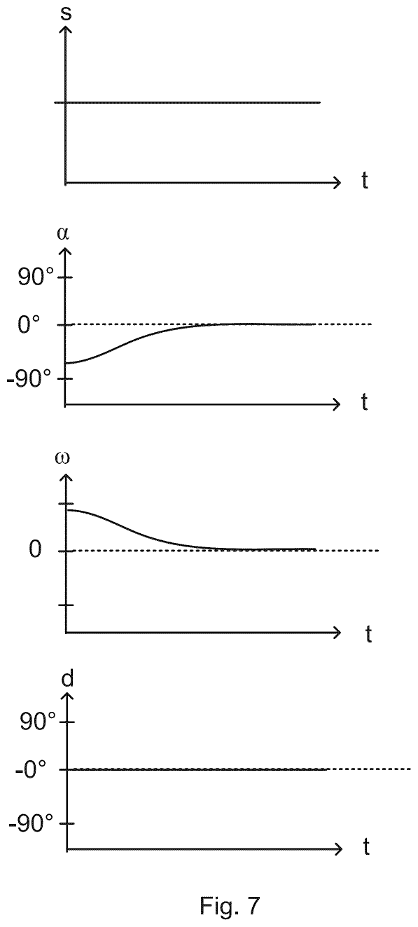

In FIG. 7, time series plots of the speed s of the articulated vehicle 10 (top graph), the articulation angle α (second graph from top), the angular speed ω (second graph from bottom) and the direction d of the articulated vehicle 10 (bottom graph) are shown along a common time axis t. The time series plots in FIG. 7 may be interpreted as describing the maneuvering of the articulated vehicles 10 in FIG. 5A, FIG. 5B and FIG. 5C or in FIG. 6A, FIG. 6B and FIG. 6C. At the start of the time series plots, the SIU 25 is released and the articulation angle α is negative. As a result, a positive angular speed ω is determined that gradually decreases as the articulation angle α approaches zero. In the time series plots of FIG. 7, the speed s and the direction d of the articulated vehicle 10 are constant.

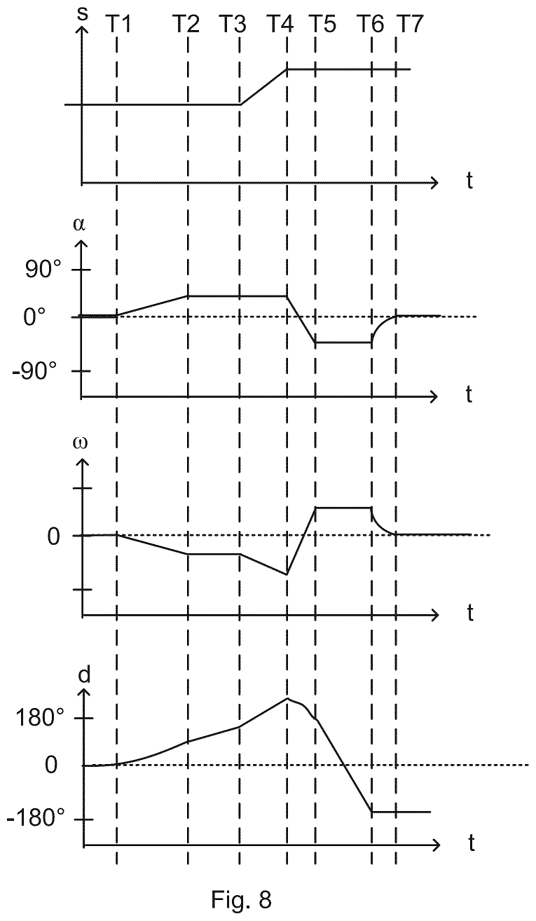

In FIG. 8, corresponding time series plots as those presented in FIG. 7 are shown along a common time axis t. In FIG. 8, an operator of the articulated vehicle 10 performs some more maneuvering than the operator in FIG. 7. At a start of the time series plots in FIG. 8, the articulated vehicle is moving forward with an articulation angle α being substantially zero.

At a first point in time T1, the articulation angle α increases. This may be due to the operator controlling the SIU 25 to provide a wanted articulation angle β changing the direction d positively. Responsive to the articulation angle α deviating from zero, a negative angular speed ω is applied to the steering system 20. The angular speed ω increases in magnitude with the articulation angle α. Assuming a steering wheel SIU 25 capable of providing haptic feedback to the operator, the operator will feel/experience the evolution of angular speed ω by the SIU 25 as being heavier/harder to rotate. This is similar to the operation of Ackermann steering where steering will be heavier/harder the more the wheel is turned.

At a second point in time T2, the operator stops rotating the SIU 25 and keeps it at a constant steering angle, thereby providing a constant wanted articulation angle ⊕. As a result, the articulation angle α is constant and so is the angular speed w. As the articulation angle α is constant but non-zero, the direction d of the articulated vehicle 10 keeps changing at a constant pace.

At a third point in time T3, the operator accelerates the articulated vehicle 10 increasing the speed s of the articulated vehicle 10. The articulation angle α is kept constant, but due to the increase in speed, the angular speed ω increases. As the operator accelerates, an increased torque will be exerted on the SIU 25 making it heavier/harder for the operator to maintain the constant steering angle and thereby provide a constant wanted articulation angle β. This is similar to the operation of Ackermann steering where steering will be heavier at increased speeds.

At a fourth point in time T4, acceleration of the articulated vehicle 10 is stopped and the speed s is kept constant. The operator rotates the SIU 25 in an opposite direction to before, changing the steering angle and thereby the wanted articulation angle β. The articulation angle α changes from positive to negative and the direction d of the articulated vehicle 10 starts to decrease. That is to say, the articulated vehicle 10 is starting to turn back. The angular speed ω tracks the articulation angle α and changes from negative to positive at a time the articulation angle α changes from positive to negative.

At a fifth point in time T5, the operator stops moving/rotating the SIU 25 and keeps the SIU 25 at a constant negative steering angle, thereby providing a constant negative wanted articulation angle β. As a result, the articulation angle α is constant and so is the angular speed ω. As the articulation angle α is constant but non-zero, the direction d of the articulated vehicle 10 keeps changing at a constant pace.

At a sixth point in time T6, the operator releases the SIU 25. The articulation angle α is controlled towards zero degrees at the angular speed ω and the SIU 25 is rotated to provide a zero steering angle and zero wanted articulation angle β. Already at the sixth point in time T6, the direction d of the articulated vehicle 10 is unchanged.

At a seventh point in time T7, the articulated vehicle 10 is controlled to continue at a constant direction d at a constant speed s.

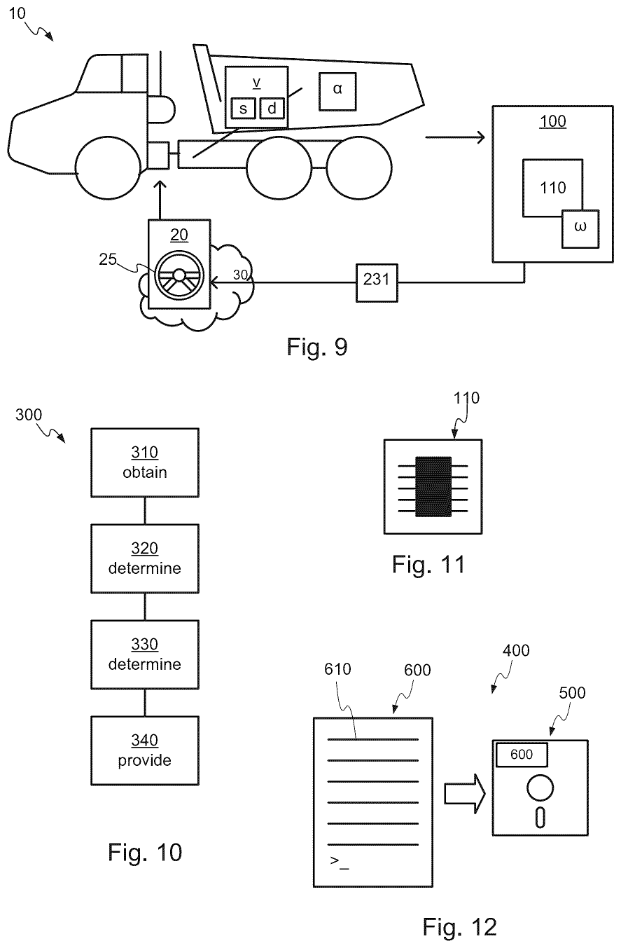

In FIG. 9, a computer system 100 comprising processing circuitry 110 is shown. The processing circuitry 110 is configured to obtain an articulation angle α of an articulated vehicle 10 and a velocity v of the articulated vehicle 10. The articulation angle α is controlled by a SIU 25 of a steering system 20 of the articulated vehicle 10. The processing circuitry 110 is further configured to, responsive to the articulation angle α deviating from 0°, determine an angular speed ω for controlling the articulation angle α towards 0° based on the articulation angle α and a magnitude s of the velocity v such that a direction d of the velocity v is maintained. The processing circuitry 110 is further configured to determine the steer-to-center torque 231 for controlling the articulation angle α towards 0° based on the angular speed ω, and to provide the steer-to-center torque 231 to the steering system 20 for control of the articulation angle α.

The StC functionality presented in the presented disclosure may replace the self-centering effect of for instance a car or any other vehicle with Ackermann steering. When a car is turning, and its steering wheel is released, it will continue travel in a straight line from where the steering wheel was released. The same effect is provided by examples of the present disclosure.

In steering systems 20 being configured as SbW systems, there is commonly another feedback torque used to dampen rotation based on an angular velocity of the SIU 25. A problem is that the StC torque and the dampening torque are working against each other, that is to say if the dampening torque is increased, the StC will be slower. A case where this is problematic is when tuning these functions. If the dampening function is tuned, the StC will also need to be tuned. However, by calculating the angular velocity ω for articulation as taught herein, and controlling the pivot joint torque 261 to achieve the angular velocity ω, this problem will not occur. Determining the angular velocity ω as taught herein improves the steer-to-center functionality, making it easier to tune and to achieve the desired behavior of the articulated vehicle 10. The StC functionality further assists in keeping the articulated vehicle 10 stable when travelling straight (forward or backward).

The teachings of the present disclosure are specifically effective when an articulated vehicle 10 is tele-operated from e.g. a rig station. Together with the camera feed from cameras mounted on the articulated vehicle 10, the StC torque 231 determined according to the present disclosure will assist the operator a lot, especially at low vehicle speeds s.

In FIG. 9, the steering system 20 is a remote steering system 20, or at least the SIU 25 is a remote SIU. As mentioned, the steering system 20 and/or the SIU 25 may be comprised in the articulated vehicle 10. Further to this, the articulated vehicle 10 may comprise the computer system 100 and/or the computer system 100 may comprise the steering system 20. In some examples, the steering system 20 comprises the computer system 100.

In FIG. 10, a method 300 is shown. The method 300 is for providing the StC torque 231 to the steering system 20 of an articulated vehicle 10. The method 300 may be a computer implemented method 300. In some examples the processing circuitry 110 of the computer system 100 may be configured to perform, or cause performance of, the method 300. In some examples the processing circuitry 21 of the steering system 20 may be configured to perform, or cause performance of, the method 300. In some examples the processing circuitry 110 of the computer system 100 and the processing circuitry 21 of the steering system 20 may be configured to co-operatively perform, or cause performance of, the method 300.

The method 300 comprises obtaining 310 the articulation angle α of the articulated vehicle 10 and a velocity v of the articulated vehicle 10. The articulation angle α is controlled by the SIU 25 of the steering system 20 of the articulated vehicle 10. The obtaining 310 may be performed according to any example or function presented herein such as those introduced with reference to FIG. 4. The method 300 further comprises, responsive to the articulation angle α deviating from 0°, determining 320 the angular speed ω for controlling the articulation angle α towards 0° based on the articulation angle α and a magnitude s of the velocity v such that the direction d of the velocity v is maintained. Also, the determining 320 of the angular speed ω may be performed according to any example or function presented herein such as those introduced with reference to FIG. 4. The method 300 further comprises determining 330 the steer-to-center torque 231 for controlling the articulation angle α towards 0° based on/according to the angular speed ω. The determining 330 of the steer-to-center torque 231 may be performed according to any example or function presented herein such as those introduced with reference to FIG. 4. The method 300 further comprises providing 340 the steer-to-center torque 231 to the steering system 20 for control of the articulation angle α.

It should be mentioned that the method 300 in FIG. 10 may be expanded to include any feature, function or example presented in the present disclosure.

In FIG. 11 processing circuitry 110 is shown. The processing circuitry 110 may be configured to cause provisioning of the StC torque 231 to a steering system 20 of an articulated vehicle 10. The processing circuitry 110 is configured to cause obtaining of the articulation angle α of the articulated vehicle 10 and a velocity v of the articulated vehicle 10. The articulation angle α is controlled by the SIU 25 of the steering system 20 of the articulated vehicle 10. The processing circuitry 110 is further configured to cause, responsive to the articulation angle α deviating from 0°, determining of the angular speed ω for controlling the articulation angle α towards 0° based on the articulation angle α and a magnitude s of the velocity v such that the direction d of the velocity v is maintained. The processing circuitry 110 is further configured to cause determining of the steer-to-center torque 231 for controlling the articulation angle α towards 0° based on/following the angular speed ω. The processing circuitry 110 is further configured to cause provisioning of the steer-to-center torque 231 to the steering system 20 for control of the articulation angle α.

The processing circuitry 110 may be further configured to cause any further feature, function or example presented in the present disclosure.

In FIG. 12 a computer program product 400 is shown. The computer program product 400 comprises a computer program 600 and a non-transitory computer readable medium 500. The computer program 600 may be stored on the computer readable medium 500. The computer readable medium 500 is, in FIG. 12, exemplified as a vintage 5.25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 600 comprises instruction 610 e.g. program instruction, software code, that, when executed by processing circuitry cause the processing circuitry to perform the method 300 introduced herein with reference to FIG. 10.

It should be mentioned that StC functionality presented herein may be provided substantially continuously. However, in some examples, the StC functionality of the present disclosure may be selectively activated by e.g. an operator pressing a button, toggling a switch or the like. The selective activation is specifically advantageous in examples wherein the SIU 25 lacks haptic feedback as this then allows an operator to decide when the vehicle 10 is to maintain the current direction d.

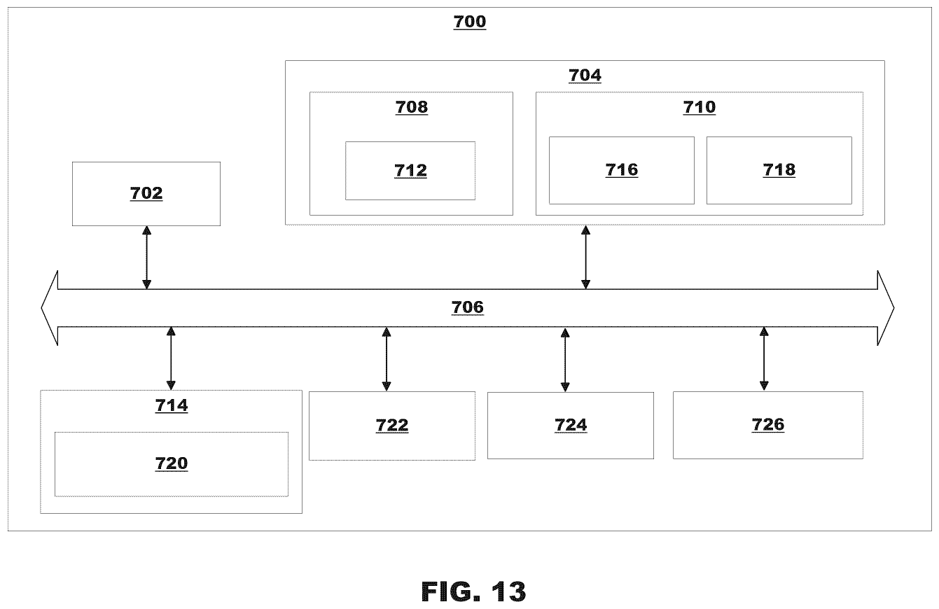

FIG. 13 is a schematic diagram of a computer system 700 for implementing examples disclosed herein. The computer system 700 is adapted to execute instructions from a computer-readable medium to perform these and/or any of the functions or processing described herein. The computer system 700 may be connected (e.g., networked) to other machines in a LAN, an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 100 may be the computer system 100 introduced with reference to FIG. 1. The computer system 700 may include processing circuitry 702 (e.g., processing circuitry including one or more processor devices or control units), a memory 704, and a system bus 706. The computer system 700 may include at least one computing device having the processing circuitry 702. The system bus 706 provides an interface for system components including, but not limited to, the memory 704 and the processing circuitry 702. The processing circuitry 702 may be or comprise the processing circuitry 110 of the computer system 100 introduced with reference to FIG. 1, and/or the processing circuitry 21 of the steering system 20 introduced with reference to FIG. 2A. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.
Example 1. A computer system 100 comprising processing circuitry 110 configured to: obtain an articulation angle α of an articulated vehicle 10 and a velocity v of the articulated vehicle 10, wherein the articulation angle α is controlled by a steering input unit, SIU, 25 of a steering system 20 of the articulated vehicle 10, responsive to the articulation angle α deviating from 0°: determine an angular speed ω for controlling the articulation angle α towards 0° based on the articulation angle α and a magnitude s of the velocity v such that a direction d of the velocity v is maintained, determine a steer-to-center torque 231 for controlling the articulation angle α towards 0° based on the angular speed w, and provide the steer-to-center torque 231 to the steering system 20 for control of the articulation angle α.
Example 2. The computer system 100 of example 1, wherein the SIU 25 is a SIU of the articulated vehicle 10.
Example 3. The computer system 100 of example 1 or 2, wherein the steering system 20 is a steer-by-wire, SbW, steering system 20.
Example 4. The computer system 100 of any one of examples 1 to 3, further comprising the steering system 20.
Example 5. The computer system 100 of example 4, wherein the processing circuitry 110 is further configured to: control a haptic feedback of the SIU 25 based on the steer-to-center torque 231.
Example 6. The computer system 100 of example 4 or 5, wherein the processing circuitry 110 is further configured to: control a hydraulic steering actuator 23 of the steering system 20 based on the steer-to-center torque 231.
Example 7. The computer system 100 of any one of examples 4 to 6, wherein the processing circuitry 110 is further configured to: obtain a wanted articulation angle β of the articulated vehicle 10, from the steering input unit, SIU, 25, and determine a wanted articulation torque 251 for controlling the articulation angle α towards the wanted articulation angle β.
Example 8. The computer system 100 of example 7, wherein the processing circuitry 110 is further configured to: control the articulation angle α by applying the wanted articulation torque 251 and the steer-to-center torque 231 to a steering actuator of the steering system 20.
Example 9. The computer system 100 of example 1, further comprising the steering system 20; wherein the SIU 25 is a SIU of the articulated vehicle 10; the steering system 20 is a steer-by-wire, SbW, steering system 20; wherein the processing circuitry 110 is further configured to: control a haptic feedback of the SIU 25 based on the steer-to-center torque 231; control a hydraulic steering actuator 23 of the steering system 20 based on the steer-to-center torque 231; obtain a wanted articulation angle β of the articulated vehicle 10, from the SIU 25, and determine a wanted articulation torque 251 for controlling the articulation angle α towards the wanted articulation angle β; control the articulation angle α by applying the wanted articulation torque 251 and the steer-to-center torque 231 to a steering actuator of the steering system 20.
Example 10. An articulated vehicle 10 comprising a steering system 20 and the computer system 100 according to any one of examples 1 to 9.
Example 11. The articulated vehicle 10 of example 10, wherein the articulated vehicle 10 is a heavy-duty vehicle.
Example 12. The articulated vehicle 10 of example 10 or 11, wherein the steering system 20 is a hydraulic steering system 20.
Example 13. The articulated vehicle 10 of any one of examples 10 to 12, wherein the articulated vehicle 10 is a SbW vehicle.
Example 14. A computer implemented method 300 comprising:
obtaining 310, by processing circuitry 110 of a computer system 100, an articulation angle α of an articulated vehicle 10 and a velocity v of the articulated vehicle 10, wherein the articulation angle α is controlled by a SIU, 25 of a steering system 20 of the articulated vehicle 10, responsive to the articulation angle α deviating from 0°: determining 320, by processing circuitry 110 of the computer system 100, an angular speed ω for controlling the articulation angle α towards 0° based on the articulation angle α and a magnitude s of the velocity v such that a direction d of the velocity v is maintained, determining 330, by processing circuitry 110 of the computer system 100, a steer-to-center torque 231 for controlling the articulation angle α towards 0° based on the angular speed ω, and providing 340, by processing circuitry 110 of the computer system 100, the steer-to-center torque 231 to the steering system 20 for control of the articulation angle α.
Example 15. The computer implemented method 300 of example 14, wherein the SIU 25 is a SIU of the articulated vehicle 10.
Example 16. The computer implemented method 300 of example 14 or 15, wherein the steering system 20 is a steer-by-wire, SbW, steering system 20.
Example 17. The computer implemented method 300 of any one of examples 14 to 16, further comprising: controlling, by processing circuitry 110 of the computer system 100, a haptic feedback of the SIU 25 of the steering system 20 based on the steer-to-center torque 231.
Example 18. The computer implemented method 300 of any one of examples 14 to 17, further comprising: controlling, by processing circuitry 110 of the computer system 100, a hydraulic steering actuator 23 of the steering system 20 based on the steer-to-center torque 231.
Example 19. The computer implemented method 300 of any one of examples 14 to 18, further comprising: obtaining, by processing circuitry 110 of the computer system 100, a wanted articulation angle β of the articulated vehicle 10, from the steering input unit, SIU, 25, and determining, by processing circuitry 110 of the computer system 100, a wanted articulation torque 251 for controlling the articulation angle α towards the wanted articulation angle β.
Example 20. The computer implemented method 300 of any one of examples 14 to 19, further comprising: controlling, by processing circuitry 110 of the computer system 100, the articulation angle α by controlling the steering system 20 to apply the wanted articulation torque 251 and the steer-to-center torque 231 to a steering actuator 23 of the steering system 20.
Example 21. A computer program product 400 comprising program code 610 for performing, when executed by a processing circuitry 110, the method of any of examples 14 to 20.
Example 22. A non-transitory computer-readable storage medium 500 comprising instructions, which when executed by a processing circuitry 110, cause the processing circuitry 110 to perform the method of any of examples 14 to 20.
Example 23. A processing circuitry 110 configured to cause: obtaining of an articulation angle α of an articulated vehicle 10 and a velocity v of the articulated vehicle 10, wherein the articulation angle α is controlled by a steering input unit, SIU, 25 of a steering system 20 of the articulated vehicle 10, responsive to the articulation angle α deviating from 0°, causing: determining of an angular speed ω for controlling the articulation angle α towards 0° based on the articulation angle α and a magnitude s of the velocity v such that a direction d of the velocity v is maintained, determining of a steer-to-center torque 231 for controlling the articulation angle α towards 0° based on the angular speed w, and provisioning of the steer-to-center torque 231 to the steering system 20 for control of the articulation angle α.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain an articulation angle of an articulated vehicle and a velocity of the articulated vehicle, wherein the articulation angle is controlled by a steering input unit (SIU) of a steering system of the articulated vehicle; and
responsive to the articulation angle deviating from 0°:
determine an angular speed for controlling the articulation angle towards 0° based on the articulation angle and a magnitude of the velocity such that a direction of the velocity is maintained;
determine a steer-to-center torque for controlling the articulation angle towards 0° based on the angular speed; and
provide the steer-to-center torque to the steering system for control of the articulation angle.

2. The computer system of claim 1, wherein the SIU is a SIU of the articulated vehicle.

3. The computer system of claim 1, wherein the steering system is a steer-by-wire (SbW) steering system.

4. The computer system of claim 1, further comprising the steering system.

5. The computer system of claim 4, wherein the processing circuitry is further configured to:
control a haptic feedback of the SIU based on the steer-to-center torque.

6. The computer system of claim 4, wherein the processing circuitry is further configured to:
control a hydraulic steering actuator of the steering system based on the steer-to-center torque.

7. The computer system of claim 4, wherein the processing circuitry is further configured to:
obtain a wanted articulation angle of the articulated vehicle, from the SIU; and
determine a wanted articulation torque for controlling the articulation angle towards the wanted articulation angle.

8. The computer system of claim 7, wherein the processing circuitry is further configured to:
control the articulation angle by applying the wanted articulation torque and the steer-to-center torque to a steering actuator of the steering system.

9. The computer system of claim 1, further comprising the steering system, wherein the SIU is a SIU of the articulated vehicle, the steering system is a sSbW steering system, wherein the processing circuitry is further configured to:
control a haptic feedback of the SIU based on the steer-to-center torque; control a hydraulic steering actuator of the steering system based on the steer-to-center torque; obtain a wanted articulation angle of the articulated vehicle, from the steering input unit (SIU); and
determine a wanted articulation torque for controlling the articulation angle towards the wanted articulation angle; and control the articulation angle by applying the wanted articulation torque and the steer-to-center torque to a steering actuator of the steering system.

10. An articulated vehicle comprising a steering system and the computer system of claim 1.

11. The articulated vehicle of claim 10, wherein the articulated vehicle is a heavy-duty vehicle.

12. The articulated vehicle of claim 10, wherein the steering system is a hydraulic steering system and the articulated vehicle is a SbW vehicle.

13. A computer implemented method comprising:
obtaining, by processing circuitry of a computer system, an articulation angle of an articulated vehicle and a velocity of the articulated vehicle, wherein the articulation angle is controlled by a steering input unit (SIU) of a steering system of the articulated vehicle; and
responsive to the articulation angle deviating from 0°:
determining, by processing circuitry of the computer system, an angular speed for controlling the articulation angle towards 0° based on the articulation angle and a magnitude of the velocity such that a direction of the velocity is maintained;
determining, by processing circuitry of the computer system, a steer-to-center torque for controlling the articulation angle towards 0° based on the angular speed; and
providing, by processing circuitry of the computer system, the steer-to-center torque to the steering system for control of the articulation angle.

14. The computer implemented method of claim 13, wherein the SIU is a SIU of the articulated vehicle.

15. The computer implemented method of claim 13, wherein the steering system is a steer-by-wire (SbW) steering system.

16. The computer implemented method of claim 13, further comprising:
controlling, by processing circuitry of the computer system, a haptic feedback of the SIU of the steering system based on the steer-to-center torque.

17. The computer implemented method of claim 13, further comprising:
controlling, by processing circuitry of the computer system, a hydraulic steering actuator of the steering system based on the steer-to-center torque.

18. The computer implemented method of claim 13, further comprising:
obtaining, by processing circuitry of the computer system, a wanted articulation angle of the articulated vehicle, from the SIU; and
determining, by processing circuitry of the computer system, a wanted articulation torque for controlling the articulation angle towards the wanted articulation angle.

19. A computer program product comprising program code for performing, when executed by a processing circuitry, the method of claim 13.

20. A non-transitory computer-readable storage medium comprising instructions, which when executed by a processing circuitry, cause the processing circuitry to perform the method of claim 13.
